(19) United States
(12) Patent Application Publication
(10) Pub. No.: US 2019/0056857 A1
(43) Pub. Date: Feb. 21, 2019

(54) RESIZING AN ACTIVE REGION OF A USER INTERFACE

(71) Applicant: Microsoft Technology Licensing, LLC, Redmond, WA (US)

(72) Inventors: Bryan K. MAMARIL, Seattle, WA (US); Jeffrey C. FONG, Seattle, WA (US)

(73) Assignee: Microsoft Technology Licensing, LLC, Redmond, WA (US)

(21) Appl. No.: 15/680,849

(22) Filed: Aug. 18, 2017

(51) Int. Cl. G06F 3/0488; G06F 3/0484

(52) U.S. Cl. CPC G06F 3/04883; G06F 2203/04808; G06F 2203/04803; G06F 3/04845

(57) ABSTRACT

A method for resizing user interfaces described herein can include detecting a reduced format gesture within an application window displayed in an active region of a user interface. The method can also include modifying the user interface to display the application window in a reduced format proximate the reduced format gesture and modifying the user interface to indicate an inactive state for a region of the user interface outside of the application window. Furthermore, the method can include detecting one or more input actions corresponding to the application window and detecting a maximize gesture within the application window. Additionally, the method can include modifying the user interface by resizing the application window to a maximized format and transitioning the region of the user interface outside of the application window from the inactive state to an active state.

### BACKGROUND

Computer devices can be coupled to any suitable number of display devices. In some examples, a single large display device or multiple interconnected display devices can depict a user interface of the computer device over a large area. Accordingly, application windows and operating system features or task bars can be separated by large distances. Depending on the size of the user interface displayed with one or more display devices, selecting features of various applications and features of an operating system from a user interface can force a user to change physical locations.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

An embodiment described herein includes a system for resizing user interfaces that includes a processor and a memory device to store a plurality of instructions that, in response to an execution of the plurality of instructions by the processor, cause the processor to detect a reduced format gesture within an application window displayed in an active region of a user interface and modify the user interface to display the application window in a reduced format proximate the reduced format gesture and modify the user interface to indicate an inactive state for a region of the user interface outside of the application window.

In another embodiment, a method for resizing user interfaces includes detecting a reduced format gesture within an application window displayed in an active region of a user interface. The method can also include modifying the user interface to display the application window in a reduced format proximate the reduced format gesture and modifying the user interface to indicate an inactive state for a region of the user interface outside of the application window. Furthermore, the method can include detecting one or more input actions corresponding to the application window and detecting a maximize gesture within the application window. In addition, the method can include modifying the user interface by resizing the application window to a maximized format and transitioning the region of the user interface outside of the application window from the inactive state to an active state.

In yet another embodiment, one or more computer-readable storage media for resizing user interfaces can include a plurality of instructions that, in response to execution by a processor, cause the processor to detect a reduced format gesture within an application window displayed in an active region of a user interface. The plurality of instructions can also cause a processor to modify the user interface to display the application window in a reduced format proximate the reduced format gesture and modify the user interface to indicate an inactive state for a region of the user interface outside of the application window. Additionally, the plurality of instructions can cause the processor to detect one or more input actions corresponding to the application window and detect a maximize gesture within the application window. Furthermore, the plurality of instructions can cause the processor to modify the user interface by resizing the application window to a maximized format and transitioning the region of the user interface outside of the application window from the inactive state to an active state.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an example of a computing system that can resize an active region of a user interface;

FIG. 2 is a process flow diagram of an example method for resizing an active region of a user interface;

FIGS. 3A-3D are block diagrams of example resized active regions of a user interface; and

FIG. 4 is a block diagram of an example computer-readable storage media that can resize an active region of a user interface.

### DETAILED DESCRIPTION

User interfaces can be generated using various techniques and can include graphical user interfaces (GUIs) for any number of applications. For example, a user interface can include a GUI for any suitable number of applications being executed, operating system features, and the like. In some embodiments, a display device or multiple interconnected display devices can display large user interfaces that may include application features and operating system features spread over large distances. In some embodiments, multiple users can also interact with one or more applications included in the user interface.

Techniques described herein provide a system for resizing an active region of a user interface. A user interface, as referred to herein, can include any suitable number of applications, operating system features, or any combination thereof. In some embodiments, the system can detect a reduced format gesture within an application window displayed in an active region of a user interface. A reduced format gesture, as referred to herein, can be any suitable gesture that indicates an active application window or active region of a user interface is to be resized to a smaller representation. Additionally, the system can modify the user interface to display the application window in a reduced format proximate the reduced format gesture and modify the user interface to indicate an inactive state for a region of the user interface outside of the application window. For example, the region of the user interface outside of the resized application window may be blurred, dimmed, or otherwise modified to indicate an inactive state.

The techniques described herein include resizing an active region of a user interface to enable a user to select application features or operating system features on large display devices without the user moving to a new physical location. For example, the techniques herein enable a user to reduce the format of an active application window or a user interface. The reduced format can enable a user to select each portion of the active application window or user interface without changing physical locations. In some examples, the techniques described herein can be incorporated into a shell or application window managed by an operating system.

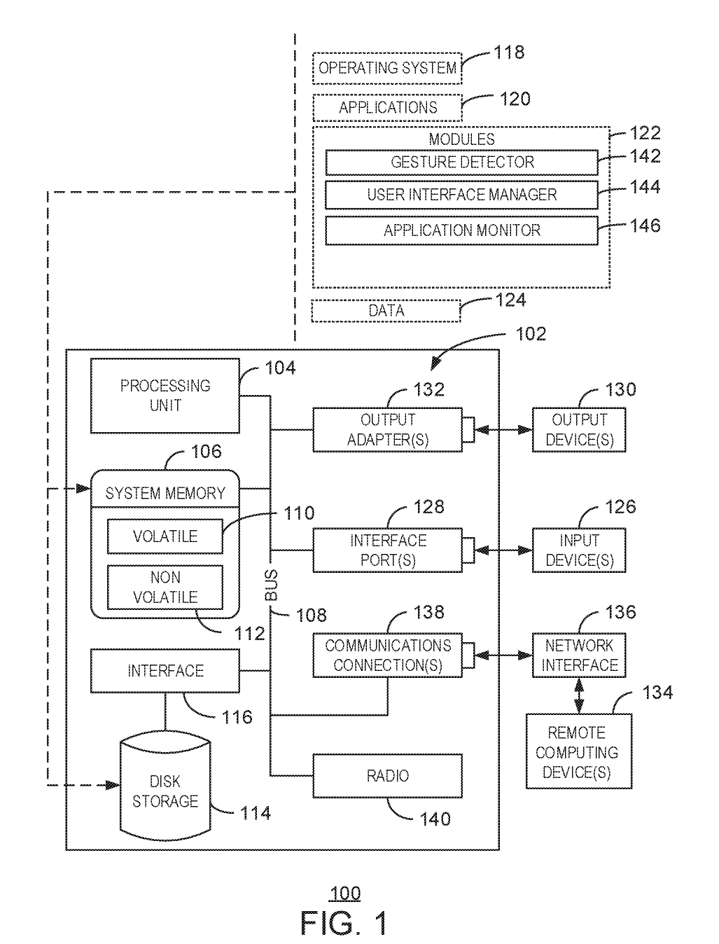

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1 discussed below, provide details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like.

FIG. 1 is a block diagram of an example of a computing system that can resize an active region of a user interface. The example system 100 includes a computing device 102. The computing device 102 includes a processing unit 104, a system memory 106, and a system bus 108. In some examples, the computing device 102 can be a gaming console, a personal computer (PC), an accessory console, a gaming controller, among other computing devices. In some examples, the computing device 102 can be a node in a cloud network.

The system bus 108 couples system components including, but not limited to, the system memory 106 to the processing unit 104. The processing unit 104 can be any of various available processors. Dual microprocessors and other multiprocessor architectures also can be employed as the processing unit 104.

The system bus 108 can be any of several types of bus structure, including the memory bus or memory controller, a peripheral bus or external bus, and a local bus using any variety of available bus architectures known to those of ordinary skill in the art. The system memory 106 includes computer-readable storage media that includes volatile memory 110 and nonvolatile memory 112.

In some embodiments, a unified extensible firmware interface (UEFI) manager or a basic input/output system (BIOS), containing the basic routines to transfer information between elements within the computer 102, such as during start-up, is stored in nonvolatile memory 112. By way of illustration, and not limitation, nonvolatile memory 112 can include read-only memory (ROM), programmable ROM (PROM), electrically programmable ROM (EPROM), electrically erasable programmable ROM (EEPROM), or flash memory.

Volatile memory 110 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 102 also includes other computer-readable media, such as removable/non-removable, volatile/non-volatile computer storage media. FIG. 1 shows, for example a disk storage 114. Disk storage 114 includes, but is not limited to, devices like a magnetic disk drive, floppy disk drive, tape drive, Jaz drive, Zip drive, LS-210 drive, flash memory card, or memory stick.

In addition, disk storage 114 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 114 to the system bus 108, a removable or non-removable interface is typically used such as interface 116.

It is to be appreciated that FIG. 1 describes software that acts as an intermediary between users and the basic computer resources described in the suitable operating environment 100. Such software includes an operating system 118. Operating system 118, which can be stored on disk storage 114, acts to control and allocate resources of the computer 102.

System applications 120 take advantage of the management of resources by operating system 118 through program modules 122 and program data 124 stored either in system memory 106 or on disk storage 114. It is to be appreciated that the disclosed subject matter can be implemented with various operating systems or combinations of operating systems.

A user enters commands or information into the computer 102 through input devices 126. Input devices 126 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, any suitable dial accessory (physical or virtual), and the like. In some examples, an input device can include Natural User Interface (NUI) devices. NUI refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. The input devices 126 connect to the processing unit 104 through the system bus 108 via interface ports 128. Interface ports 128 include, for example, a serial port, a parallel port, a game port, and a universal serial bus (USB).

Output devices 130 use some of the same type of ports as input devices 126. Thus, for example, a USB port may be used to provide input to the computer 102 and to output information from computer 102 to an output device 130.

Output adapter 132 is provided to illustrate that there are some output devices 130 like monitors, speakers, and printers, among other output devices 130, which are accessible via adapters. The output adapters 132 include, by way of illustration and not limitation, video and sound cards that provide a means of connection between the output device 130 and the system bus 108. It can be noted that other devices and systems of devices provide both input and output capabilities such as remote computing devices 134.

The computer 102 can be a server hosting various software applications in a networked environment using logical connections to one or more remote computers, such as remote computing devices 134. The remote computing devices 134 may be client systems configured with web browsers, PC applications, mobile phone applications, and the like. The remote computing devices 134 can be a personal computer, a server, a router, a network PC, a workstation, a microprocessor based appliance, a mobile phone, a peer device or other common network node and the like, and typically includes many or all of the elements described relative to the computer 102.

Remote computing devices 134 can be logically connected to the computer 102 through a network interface 136 and then connected via a communication connection 138, which may be wireless. Network interface 136 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 138 refers to the hardware/software employed to connect the network interface 136 to the bus 108. While communication connection 138 is shown for illustrative clarity inside computer 102, it can also be external to the computer 102. The hardware/software for connection to the network interface 136 may include, for exemplary purposes, internal and external technologies such as, mobile phone switches, modems including regular telephone grade modems, cable modems and DSL modems, ISDN adapters, and Ethernet cards.

The computer 102 can further include a radio 140. For example, the radio 140 can be a wireless local area network radio that may operate one or more wireless bands. For example, the radio 140 can operate on the industrial, scientific, and medical (ISM) radio band at 2.4 GHz or 5 GHz. In some examples, the radio 140 can operate on any suitable radio band at any radio frequency.

The computer 102 includes one or more modules 122, such as a gesture detector 142, a user interface manager 144, and an application monitor 146. In some embodiments, the gesture detector 142 can detect a reduced format gesture within an application window displayed in an active region of a user interface. In some embodiments, the user interface manager 144 can modify the user interface to display the application window in a reduced format proximate the reduced format gesture and modify the user interface to indicate an inactive state for a region of the user interface outside of the application window. In some embodiments, the application monitor 146 can detect one or more input actions corresponding to the application window. The application monitor 146 can also detect a maximize gesture within the application window. Furthermore, the user interface manager 144 can modify the user interface by resizing the application window to a maximized format and transitioning the region of the user interface outside of the application window from the inactive state to an active state.

It is to be understood that the block diagram of FIG. 1 is not intended to indicate that the computing system 102 is to include all of the components shown in FIG. 1. Rather, the computing system 102 can include fewer or additional components not illustrated in FIG. 1 (e.g., additional applications, additional modules, additional memory devices, additional network interfaces, etc.). Furthermore, any of the functionalities of the gesture detector 142, user interface manager 144, and application monitor 146 may be partially, or entirely, implemented in hardware and/or in the processing unit (also referred to herein as a processor) 104. For example, the functionality may be implemented with an application specific integrated circuit, in logic implemented in the processing unit 104, or in any other device.

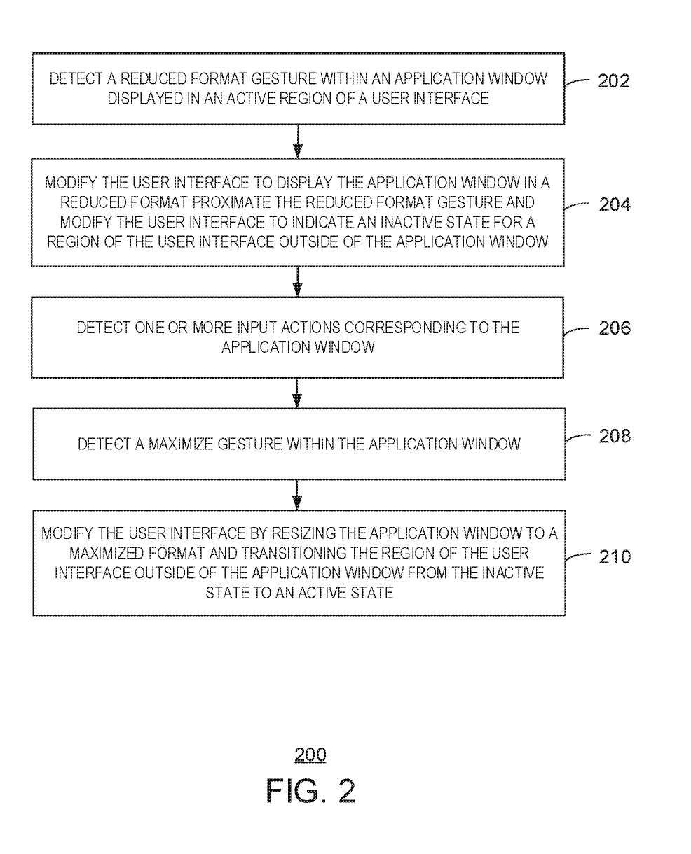

FIG. 2 is a process flow diagram of an example method for resizing an active region of a user interface. The method 200 can be implemented with any suitable computing device, such as the computing system 102 of FIG. 1.

At block 202, a gesture detector 142 can detect a reduced format gesture within an application window displayed in an active region of a user interface. An active region of a user interface can include any suitable application window, operating system feature, or the like, that is displayed in the forefront of the user interface and accepts user input. In some examples, the reduced format gesture can include any number of fingers or any other portion of a hand or hands interacting with a display device. For example, the reduced format gesture can include a one finger touch of the display device, a two finger touch of the display device, or any additional number of fingers touching the display device. In some embodiments, the reduced format gesture can include two hands contacting a region of a display device. For example, the reduced format gesture can include ten fingers contacting a display device and swiping the display device in a particular direction. In some examples, the reduced format gesture can be based on a contact threshold value that indicates a size and shape of a region of the display device in which a reduced format gesture can be detected. In some examples, the area of the region corresponds to any suitable touch of a display device. For example, a first finger touching the display device can indicate that additional fingers or hands touching the display device can be considered part of the reduced format gesture within a particular distance from the first finger contact. In some embodiments, the reduced format gesture can also include a temporal component. For example, the reduced format gesture may include any number of fingers or hands contacting the display device within a particular region within a particular time frame. In some examples, a delay between touching two fingers to the display device can result in separate reduced format gestures being detected.

In some embodiments, the display device can extrapolate a reduced format gesture based on a movement proximate a display device. For example, the gesture detector 142 can use cameras coupled to a system to detect contactless gestures targeting portions of the display device. The gesture detector 142 can extrapolate or determine the location of the display device being selected based on the contactless gesture.

At block 204, a user interface manager 144 can modify the user interface to display the application window in a reduced format adjacent to the reduced format gesture and modify the user interface to indicate an inactive state for a region of the user interface outside of the application window. As discussed above in relation to block 202, any suitable reduced format gesture can be linked to the displaying of an active region of a user interface in a reduced format. In some embodiments, the user interface manager 144 can detect different reduced format gestures used to generate reduced formats for different applications. For example, a first application may use a reduced format gesture with two fingers to generate a reduced format of a particular size and a second application may use a reduced format gesture with three fingers to generate a reduced format of a different size.

In some embodiments, the user interface manager 146 can generate or display a reduced format application window based on a plurality of rules corresponding to a layout of the user interface. The plurality of rules can indicate how to display reduced format application windows. For example, the reduced format application windows can be generated in relation to other visual elements such as an application launcher, an application switcher, and a window list, among others. An application launcher, as referred to herein, can include a list of executable applications installed on a system, a list of recently accessed applications installed on the system, recommended applications to be installed on the system, and the like. In some examples, the application launcher can include commands that can access programs, documents, and settings. These commands can include a search function based on locally stored applications and files, a list of documents available locally on a device or on a remote server, a control panel to configure components of a device, power function commands to alter the power state of the device, and the like. An application switcher, as referred to herein, can include a link to a digital assistant, a task view illustrating all open applications, a set of icons corresponding to applications being executed, and various icons corresponding to applications and hardware features that are enabled each time a device receives power. In some embodiments, any of the features from the application switcher or application launcher can be included in a reduced format application window.

In some embodiments, the plurality of rules can indicate an area of a screen that is to be occupied by the reduced format application window. In some examples, reduced format application windows can be displayed in regions of a display device based on the rules. For example, the location of a reduced format application window may depend upon a location of the reduced format gesture, a size of the display device, and the like. For example, the reduced format application window can be placed above, below, left, right, centered, or diagonal to the reduced format gesture location. In some embodiments, the reduced format application window can be displayed proximate a reduced format gesture location so that the reduced format application window is adjacent to a border of the display device, or centered within a display device.

At block 206, an application monitor 146 can detect one or more input actions corresponding to the application window. An input action, as referred to herein, can include any suitable user input corresponding to a reduced format of an active region of a user interface. For example, an input action can include any suitable number of input characters, a selection of an editing function, and the like. In some examples, the input action can include any suitable input detected by an application window being displayed in a reduced format. In some embodiments, any suitable number of applications in the active region of a user interface can be displayed in a reduced format and the input actions can correspond to the applications.

At block 208, the application monitor 146 can detect a maximize gesture within the application window. In some embodiments, any suitable gesture can be detected within the reduced format of the active region of a user interface to indicate that the active region of the user interface is to be transitioned to a maximized format. In some examples, the maximize gesture can include any gesture that is distinguishable from the reduced format gesture. For example, the maximize gesture can include any number of fingers or any other portion of a hand or hands interacting with a display device. For example, the maximize format gesture can include a one finger touch of the display device, a two finger touch of the display device, or any additional number of fingers touching the display device. In some embodiments, the maximize gesture can include two hands contacting a region of a display device. For example, the maximize gesture can include two hands contacting the region of the display device corresponding to the reduced format of an application window and swiping in an opposite direction of the reduced format gesture.

In some examples, the maximize gesture can be based on a contact threshold value that indicates a size and shape of a region of the display device in which a reduced format gesture can be detected. In some examples, the area of the region corresponds to any suitable touch of a display device. For example, a first finger touching the display device can indicate that additional fingers or hands touching the display device can be considered part of the maximize gesture within a particular distance from the first finger contact. In some embodiments, the maximize gesture can also include a temporal component. For example, the maximize gesture may include any number of fingers or hands contacting the display device within a particular region within a particular time frame.

At block 210, the user interface manager 144 can modify the user interface by resizing the application window to a maximized format and transitioning the region of the user interface outside of the application window from the inactive state to an active state. The active state, as referred to herein, can include a state in which any portion of the user interface can be selected and viewed in a standard setting. For example, the active state can include a state in which the user interface enables input corresponding to any number of background application windows, application windows displayed on multiple display devices, operating system features displayed on any number of display devices, and the like. In some examples, transitioning from an inactive state to an active state can include changing an inactive region of a user interface from a blurred view to a standard view to indicate that the various features of the inactive region of the user interface are functional. In some examples, the reduced format application window is replaced with a larger representation of the application window corresponding to a size of the application window when the reduced format gesture was detected.

In one embodiment, the process flow diagram of FIG. 2 is intended to indicate that the blocks of the method 200 are to be executed in a particular order. Alternatively, in other embodiments, the blocks of the method 200 can be executed in any suitable order and any suitable number of the blocks of the method 200 can be included. Further, any number of additional blocks may be included within the method 200, depending on the specific application. In some embodiments, the method 200 can include displaying the user interface with a display screen that exceeds a predetermined screen threshold. For example, a single display device may exceed a predetermined screen threshold indicating that a reduced format gesture can reduce the region of the display device that displays an active application window. Alternatively, the method 200 can include displaying the user interface with two or more display screens. In some embodiments, the method 200 can include detecting a reduced format gesture within the user interface in a state in which the application window is not displayed. The method 200 can also include resizing the user interface to a reduced format proximate the reduced format gesture and modifying the user interface to indicate an inactive state for a region of a display screen no longer corresponding to the user interface. In some embodiments, the method 200 can also include detecting a maximize gesture within the reduced format of the user interface and resizing the user interface a maximized format and transition the region of the user interface outside of the reduced format from the inactive state to an active state.

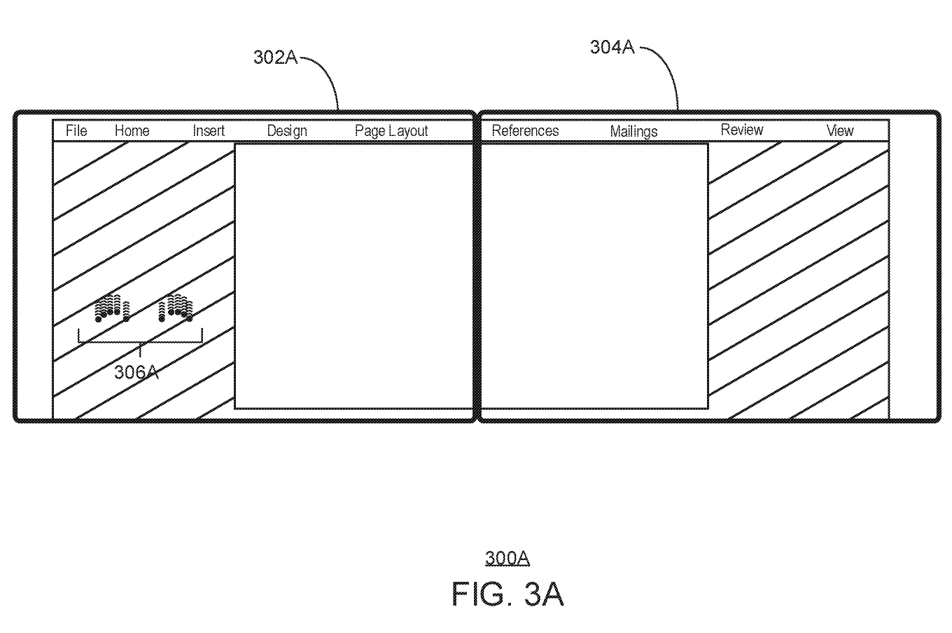

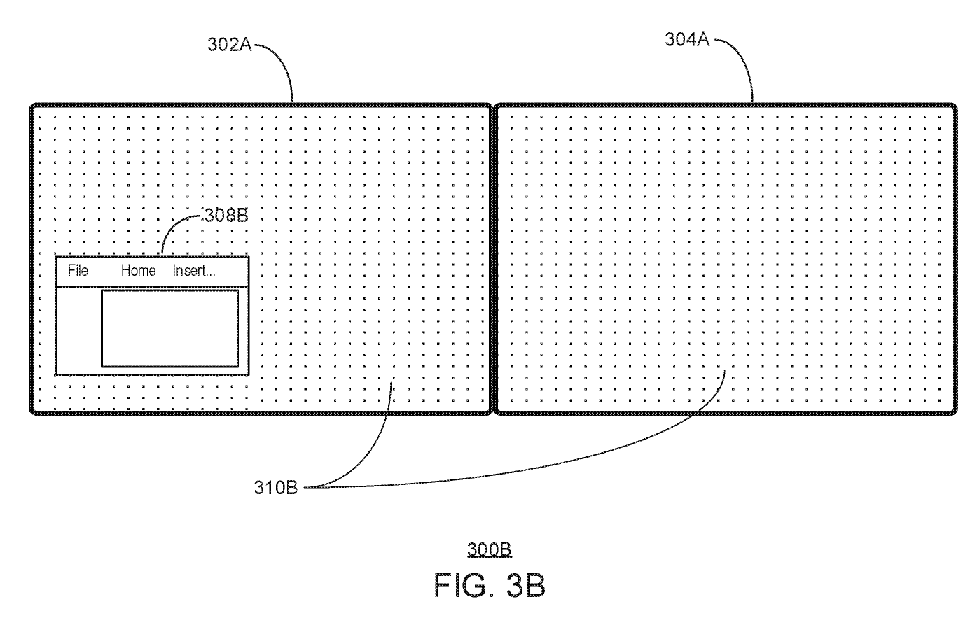

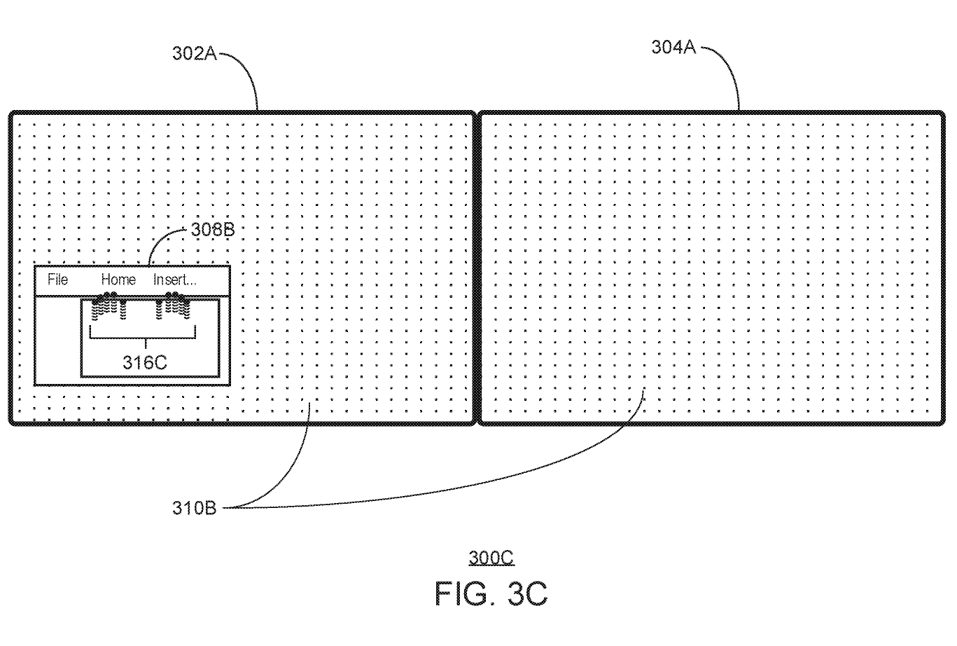

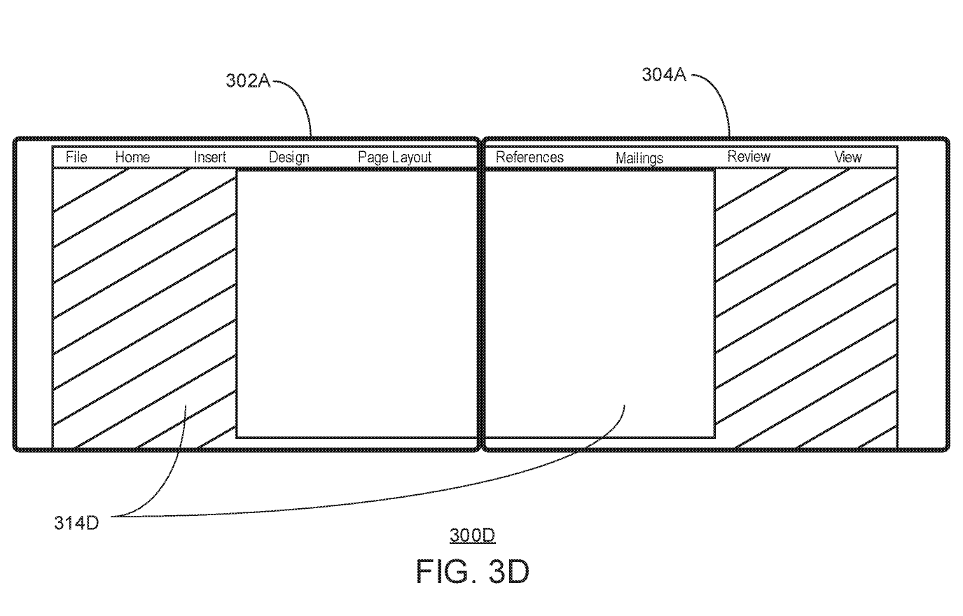

FIGS. 3A-3D are block diagrams of example resized active regions of a user interface. In the user interface 300A of FIG. 3A, the active region of the user interface 300A can span two display devices 302A and 304A. The active region of the user interface 300A can include an application window displayed across the two display devices 302A and 304A. A reduced format gesture 306A can be detected in any of the two display devices 302A and 304A. For example, ten fingers contacting any one of the two display devices 302A and 304A with a downward motion can indicate a reduced format gesture. In some embodiments, any suitable reduced format gesture described above in relation to FIG. 2 can be detected. In some examples, the reduced format gesture comprises contact from two hands in a motion towards a bottom of a display screen displaying the application window.

In FIG. 3B, the user interface 300B illustrates an example reduced format of an active region of a user interface and an inactive state of a region of the user interface 300B outside of the reduced format area. For example, the application window of FIG. 3A can be displayed in a single display device 302A. In some examples, the reduced format application window 308B can be displayed proximate or adjacent to a location of the reduced format gesture. For example, the reduced format of the application window 308B can be displayed above, below, to the left, or to the right of the contact point of the reduced format gesture 306A. In FIG. 3B, the reduced format of the application window 308B is centered upon a location at which the reduced format gesture 306A was previously detected. The inactive regions 310B of the user interface 300B outside of the reduced format of the application window 308B can be dimmed, blackened, blurred, and the like, to indicate the inactive state of the inactive regions 310B. As discussed above, the inactive regions 310B may not accept user input or provide any information. In some embodiments, the inactive regions 310B can display a blurred or dimmed version of the application window in an original state prior to the reduced format gesture 306A.

In FIG. 3C, the user interface 300C illustrates a detection of a maximize gesture 312C provided within the reduced format of the application window 308B. For example, the maximize gesture 312C can include ten fingers or contact points in an upward direction, downward direction, to the left, or to the right of the display device 302A. In some examples, the maximize gesture 312C is performed in an opposite direction of the reduced format gesture 3A. For example, the maximize gesture 312C can include contact from two hands in a motion towards a top of a display screen 302A displaying the application window. In the user interface 300C, the inactive regions 310B of the user interface 300C are depicted in an inactive state. In some embodiments, the inactive regions 310B can display a blurred or dimmed version of the application window in an original state prior to the reduced format gesture 306A.

In FIG. 3D, the user interface 300D includes an active region of an application window 314D displayed across two display devices 302A and 304A in response to detecting the maximize gesture 312C. In some examples, the maximize gesture 312C can restore the active region of the application window 314D to any suitable number of the display devices 302A and 304A. In FIG. 3D, the user interface 300D is transitioned to an active state and an inactive state of the user interface 300D is not represented. In some examples, the application window is maximized to a size corresponding to the size of the application window when the reduced gesture format was previously detected. In some embodiments, the application window of user interface 300D can display any changes provided to the application during a time period in which the application window was in a reduced format.

In some embodiments, the user interfaces 300A-300D can be generated based on rules. For example, the rules can indicate a location and size of the reduced format of the active region of the user interface 308B based on the location of an application window displayed within a display device. In some examples, the rules can be written in an Extensible Application Markup Language (XAML), HTML, and the like, to imperatively or declaratively describe the rules which result in the creation of the reduced format of the active region of a user interface 308B.

It is to be understood that the block diagrams of FIGS. 3A-3D are not intended to indicate that the user interfaces 300A-300D contain all of the components shown in FIG. 3A-3D. Rather, the user interfaces 300A-300D can include fewer or additional components not illustrated in FIGS. 3A-3D (e.g., additional application features, additional operating system features, etc.).

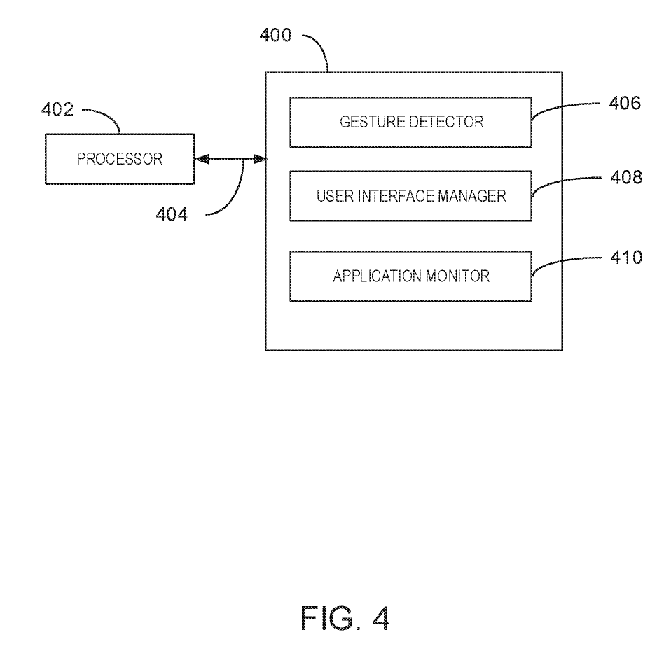

FIG. 4 is a block diagram of an example computer-readable storage media that can resize an active region of a user interface. The tangible, computer-readable storage media 400 may be accessed by a processor 402 over a computer bus 404. Furthermore, the tangible, computer-readable storage media 400 may include code to direct the processor 402 to perform the steps of the current method.

The various software components discussed herein may be stored on the tangible, computer-readable storage media 400, as indicated in FIG. 4. For example, the tangible computer-readable storage media 400 can include a gesture detector 406 that can detect a reduced format gesture within an application window displayed in an active region of a user interface. In some embodiments, a user interface manager 408 can modify the user interface to display the application window in a reduced format proximate the reduced format gesture and modify the user interface to indicate an inactive state for a region of the user interface outside of the application window. In some embodiments, an application monitor 410 can detect one or more input actions corresponding to the application window. The application monitor 410 can also detect a maximize gesture within the application window. Furthermore, the user interface manager 408 can modify the user interface by resizing the application window to a maximized format and transitioning the region of the user interface outside of the application window from the inactive state to an active state.

It is to be understood that any number of additional software components not shown in FIG. 4 may be included within the tangible, computer-readable storage media 400, depending on the specific application.

### EXAMPLE 1

In one embodiment, a system for resizing an active region of a user interface includes a processor and a memory device to store a plurality of instructions that, in response to an execution of the plurality of instructions by the processor, cause the processor to detect a reduced format gesture within an application window displayed in an active region of a user interface and modify the user interface to display the application window in a reduced format proximate the reduced format gesture and modify the user interface to indicate an inactive state for a region of the user interface outside of the application window.

Alternatively, or in addition, the plurality of instructions can cause the processor to detect one or more input actions corresponding to the application window, detect a maximize gesture within the application window, and modify the user interface by resizing the application window to a maximized format and transitioning the region of the user interface outside of the application window from the inactive state to an active state. Alternatively, or in addition, the plurality of instructions cause the processor to detect the reduced format gesture in response to displaying the user interface with a display screen that exceeds a predetermined screen threshold. Alternatively, or in addition, the plurality of instructions cause the processor to display the user interface with two or more display screens. Alternatively, or in addition, the reduced format gesture comprises contact from two hands in a motion towards a bottom of a display screen displaying the application window. Alternatively, or in addition, the maximize gesture comprises contact from two hands in a motion towards a top of a display screen displaying the application window. Alternatively, or in addition, the plurality of instructions cause the processor to detect a reduced format gesture within the user interface in a state in which the application window is not displayed, and resize the user interface to a reduced format proximate the reduced format gesture and modify the user interface to indicate an inactive state for a region of a display screen no longer corresponding to the user interface. Alternatively, or in addition, the plurality of instructions cause the processor to detect a maximize gesture within the reduced format of the user interface and resize the user interface to a maximized format and transition the region of the user interface outside of the reduced format from the inactive state to an active state. Alternatively, or in addition, the reduced format gesture comprises contact from ten fingers.

### EXAMPLE 2

In another embodiment, a method for resizing user interfaces includes detecting a reduced format gesture within an application window displayed in an active region of a user interface. The method can also include modifying the user interface to display the application window in a reduced format proximate the reduced format gesture and modifying the user interface to indicate an inactive state for a region of the user interface outside of the application window. Furthermore, the method can include detecting one or more input actions corresponding to the application window and detecting a maximize gesture within the application window. In addition, the method can include modifying the user interface by resizing the application window to a maximized format and transitioning the region of the user interface outside of the application window from the inactive state to an active state.

Alternatively, or in addition, the method can include detecting the reduced format gesture in response to displaying the user interface with a display screen that exceeds a predetermined screen threshold. Alternatively, or in addition, the method can include displaying the user interface with two or more display screens. Alternatively, or in addition, the reduced format gesture comprises contact from two hands in a motion towards a bottom of a display screen displaying the application window. Alternatively, or in addition, the maximize gesture comprises contact from two hands in a motion towards a top of a display screen displaying the application window. Alternatively, or in addition, the method can include detecting a reduced format gesture within the user interface in a state in which the application window is not displayed, and resizing the user interface to a reduced format proximate the reduced format gesture and modify the user interface to indicate an inactive state for a region of a display screen no longer corresponding to the user interface. Alternatively, or in addition, the method can include detecting a maximize gesture within the reduced format of the user interface and resizing the user interface to a maximized format and transition the region of the user interface outside of the reduced format from the inactive state to an active state. Alternatively, or in addition, the reduced format gesture comprises contact from ten fingers.

### EXAMPLE 3

In yet another embodiment, one or more computer-readable storage media for resizing user interfaces can include a plurality of instructions that, in response to execution by a processor, cause the processor to detect a reduced format gesture within an application window displayed in an active region of a user interface. The plurality of instructions can also cause a processor to modify the user interface to display the application window in a reduced format proximate the reduced format gesture and modify the user interface to indicate an inactive state for a region of the user interface outside of the application window. Additionally, the plurality of instructions can cause the processor to detect one or more input actions corresponding to the application window and detect a maximize gesture within the application window. Furthermore, the plurality of instructions can cause the processor to modify the user interface by resizing the application window to a maximized format and transitioning the region of the user interface outside of the application window from the inactive state to an active state.

Alternatively, or in addition the plurality of instructions can cause the processor to detect the reduced format gesture in response to displaying the user interface with a display screen that exceeds a predetermined screen threshold. Alternatively, or in addition, the plurality of instructions can cause the processor to display the user interface with two or more display screens. Alternatively, or in addition, the reduced format gesture comprises contact from two hands in a motion towards a bottom of a display screen displaying the application window. Alternatively, or in addition, the maximize gesture comprises contact from two hands in a motion towards a top of a display screen displaying the application window. Alternatively, or in addition, the plurality of instructions can cause the processor to detect a reduced format gesture within the user interface in a state in which the application window is not displayed, and resize the user interface to a reduced format proximate the reduced format gesture and modify the user interface to indicate an inactive state for a region of a display screen no longer corresponding to the user interface. Alternatively, or in addition, the plurality of instructions can cause the processor to detect a maximize gesture within the reduced format of the user interface and resize the user interface to a maximized format and transition the region of the user interface outside of the reduced format from the inactive state to an active state. Alternatively, or in addition, the reduced format gesture comprises contact from ten fingers.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for resizing user interfaces, comprising:
a processor; and
a memory comprising a plurality of instructions that, in response to an execution by the processor, cause the processor to:
detect a reduced format gesture within an application window displayed in an active region of a user interface; and
modify the user interface to display the application window in a reduced format proximate the reduced format gesture and modify the user interface to indicate an inactive state for a region of the user interface outside of the application window.

2. The system of claim 1, wherein the plurality of instructions cause the processor to:
detect one or more input actions corresponding to the application window;
detect a maximize gesture within the application window; and
modify the user interface by resizing the application window to a maximized format and transitioning the region of the user interface outside of the application window from the inactive state to an active state.

3. The system of claim 1, wherein the plurality of instructions cause the processor to detect the reduced format gesture in response to displaying the user interface with a display screen that exceeds a predetermined screen threshold.

4. The system of claim 1, wherein the plurality of instructions cause the processor to display the user interface with two or more display screens.

5. The system of claim 1, wherein the reduced format gesture comprises contact from two hands in a motion towards a bottom of a display screen displaying the application window.

6. The system of claim 2, wherein the maximize gesture comprises contact from two hands in a motion towards a top of a display screen displaying the application window.

7. The system of claim 1, wherein the plurality of instructions cause the processor to:
detect a reduced format gesture within the user interface in a state in which the application window is not displayed; and
resize the user interface to a reduced format proximate the reduced format gesture and modify the user interface to indicate an inactive state for a region of a display screen no longer corresponding to the user interface.

8. The system of claim 7, wherein the plurality of instructions cause the processor to:
detect a maximize gesture within the reduced format of the user interface; and
resize the user interface to a maximized format and transition the region of the user interface outside of the reduced format from the inactive state to an active state.

9. The system of claim 5, wherein the reduced format gesture comprises contact from ten fingers.

10. A method for resizing user interfaces, comprising:
detecting a reduced format gesture within an application window displayed in an active region of a user interface;
modifying the user interface to display the application window in a reduced format proximate the reduced format gesture and modifying the user interface to indicate an inactive state for a region of the user interface outside of the application window;
detecting one or more input actions corresponding to the application window;
detecting a maximize gesture within the application window; and
modifying the user interface by resizing the application window to a maximized format and transitioning the region of the user interface outside of the application window from the inactive state to an active state.

11. The method of claim 10, wherein the method comprises detecting the reduced format gesture in response to displaying the user interface with a display screen that exceeds a predetermined screen threshold.

12. The method of claim 10, wherein the method comprises displaying the user interface with two or more display screens.

13. The method of claim 10, wherein the reduced format gesture comprises contact from two hands in a motion towards a bottom of a display screen displaying the application window.

14. The method of claim 10, wherein the maximize gesture comprises contact from two hands in a motion towards a top of a display screen displaying the application window.

15. The method of claim 10, wherein the method comprises:
detecting a reduced format gesture within the user interface in a state in which the application window is not displayed; and
resizing the user interface to a reduced format proximate the reduced format gesture and modifying the user interface to indicate an inactive state for a region of a display screen no longer corresponding to the user interface.

16. The method of claim 15, wherein the method comprises:
detecting the maximize gesture within the reduced format of the user interface; and
resizing the user interface to a maximized format and transitioning the region of the user interface outside of the reduced format from the inactive state to an active state.

17. The method of claim 10, wherein the reduced format gesture comprises contact from ten fingers.

18. One or more computer-readable storage media for resizing user interfaces, wherein the one or more computer-readable storage media comprise a plurality of instructions that, in response to execution by a processor, cause the processor to:
detect a reduced format gesture within an application window displayed in an active region of a user interface;
modify the user interface to display the application window in a reduced format proximate the reduced format gesture and modify the user interface to indicate an inactive state for a region of the user interface outside of the application window;
detect one or more input actions corresponding to the application window;
detect a maximize gesture within the application window; and
modify the user interface by resizing the application window to a maximized format and transitioning the region of the user interface outside of the application window from the inactive state to an active state.

19. The one or more computer-readable storage media of claim 18, wherein the plurality of instructions cause the processor to detect the reduced format gesture in response to displaying the user interface with a display screen that exceeds a predetermined screen threshold.

20. The one or more computer-readable storage media of claim 18, wherein the plurality of instructions cause the processor to display the user interface with two or more display screens.
